(19) United States
(12) Patent Application Publication
(10) Pub. No.: US 2025/0266579 A1
(43) Pub. Date: Aug. 21, 2025

(54) POWER STORAGE MODULE AND POWER STORAGE DEVICE

(71) Applicant: TOYOTA JIDOSHA KABUSHIKI KAISHA, Toyota-shi Aichi-ken (JP)

(72) Inventors: Yusuke KINTSU, Miyoshi-shi Aichi-ken (JP); Shinya ISHIKAWA, Anjo-shi Aichi-ken (JP); Takumi TANAKA, Toyota-shi Aichi-ken (JP); Masayoshi HAGA, Nagoya-shi Aichi-ken (JP); Kazuki MURAISHI, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/017,989

(22) Filed: Jan. 13, 2025

(30) Foreign Application Priority Data
Feb. 21, 2024 (JP) 2024-024304

(51) Int. Cl. H01M 50/503; H01M 50/103; H01M 50/209; H01M 50/249; H01M 50/30; H01M 50/55; H01M 50/627

(52) U.S. Cl. CPC H01M 50/503; H01M 50/103; H01M 50/209; H01M 50/249; H01M 50/30; H01M 50/55; H01M 50/627; H01M 2200/20; H01M 2220/20

(57) ABSTRACT

A power storage module includes a plurality of single cells. The plurality of the single cells are stacked in a stacking direction. Each of the plurality of the single cells includes a case. The case has a rectangular-parallelepiped-like shape with six outer surfaces. The six outer surfaces include a terminal surface and an opposite surface. The terminal surface is an outer surface, among the six outer surfaces, to which a positive electrode terminal and a negative electrode terminal are provided. The opposite surface is an outer surface, among the six outer surfaces, that is located opposite to the terminal surface. Each of the terminal surface and the opposite surface is parallel to the stacking direction. The plurality of the single cells are aligned in the stacking direction in such a manner that the terminal surface alternates with the opposite surface.

### CROSS REFERENCE TO RELATED APPLICATIONS

This nonprovisional application is based on Japanese Patent Application No. 2024-024304 filed on Feb. 21, 2024, with the Japan Patent Office, the entire contents of which are hereby incorporated by reference.

### BACKGROUND OF THE DISCLOSURE

### Field of the Disclosure

The present disclosure relates to a power storage module and a power storage device.

### Description of the Background Art

Japanese Patent Laying-Open No. 2014-232735 discloses a power storage module that has a structure where at the time when internal pressure of single cells rises, gaps between the single cells remain open and air can flow around the single cells.

### SUMMARY OF THE DISCLOSURE

A power storage module includes a plurality of single cells. Each single cell may have a single terminal surface. “Terminal surface” refers to an outer surface, among the outer surfaces of the single cell, to which a terminal is provided. When there is only one terminal surface, both a positive electrode terminal and a negative electrode terminal are provided to the only one outer surface. When there is only one terminal surface, the local temperature near the terminal surface tends to be high. As a result, unevenness in the temperature of the power storage module can be great.

An object of the present disclosure is to reduce unevenness in the temperature of a power storage module.

Hereinafter, the technical configuration and effects of the present disclosure will be described. It should be noted that the action mechanism includes presumption. The action mechanism does not limit the technical scope of the present disclosure.

1. A power storage module includes a plurality of single cells. The plurality of the single cells are stacked in a stacking direction. Each of the plurality of the single cells includes a case. The case has a rectangular-parallelepiped-like shape with six outer surfaces. The six outer surfaces include a terminal surface and an opposite surface. The terminal surface is an outer surface, among the six outer surfaces, to which a positive electrode terminal and a negative electrode terminal are provided. The opposite surface is an outer surface, among the six outer surfaces, that is located opposite to the terminal surface. Each of the terminal surface and the opposite surface is parallel to the stacking direction. The plurality of the single cells are aligned in the stacking direction in such a manner that the terminal surface alternates with the opposite surface.

In a single cell, the temperature of an opposite surface located opposite to a terminal surface tends to be lower than that of the terminal surface. When single cells are aligned in such a manner that the terminal surface alternates with the opposite surface, high-temperature areas (terminal surfaces) are scattered within the power storage module. In addition, between adjacent single cells, the terminal surface of one single cell is adjacent to the opposite surface of the other single cell. It is expected that heat can be diffused from the terminal surface of one single cell to the opposite surface of the other single cell. These actions are expected to synergistically reduce unevenness in temperature. Hereinafter, an arrangement in which a terminal surface alternates with an opposite surface is also called “an alternate arrangement”.

2. The power storage module according to “1” above may include the following configuration, for example. The six outer surfaces further include four connection surfaces. Each of the four connection surfaces connects the terminal surface and the opposite surface to each other. Among all facing pairs out of the six outer surfaces, the terminal surface and the opposite surface have the longest distance between them.

In a single cell, as the distance between the terminal surface and the opposite surface increases, the difference in temperature between the terminal surface and the opposite surface can also increase. The longer the distance between the terminal surface and the opposite surface is, the more effective the alternate arrangement may be.

3. The power storage module according to “1” or “2” above may include the following configuration, for example. The power storage module further includes a bus bar. The bus bar extends in the stacking direction. The bus bar connects two of the single cells together, leaving one single cell sandwiched therebetween.

In an alternate arrangement, two single cells may be connected together leaving one single cell sandwiched therebetween.

4. The power storage module according to according to any one of “1” to “3” above may include the following configuration, for example. At least one of a liquid inlet hole and a gas-discharge valve is provided to the opposite surface.

5. The power storage module according to “4” above may include the following configuration, for example. The gas-discharge valve is provided to the opposite surface. In a plane viewed in a direction of a normal to the opposite surface, the bus bar has a shape that does not overlap the gas-discharge valve.

In the case where the bus bar overlaps the gas-discharge valve, the bus bar can interfere with the gas-discharge valve. When the bus bar does not overlap the gas-discharge valve, the gas-discharge valve may function smoothly.

6. The power storage module according to “3” above may include the following configuration, for example. The bus bar extends in such a manner that it straddles the opposite surface present between the terminal surfaces. The bus bar includes a portion that extends in a direction away from the opposite surface.

With the bus bar extending in a direction away from the opposite surface, interference from the bus bar on an adjacent single cell may be reduced. The entire bus bar may lie away from the opposite surface, or a part of it may lie away from the opposite surface. The bus bar may lie away from the opposite surface at some position(s).

7. The power storage module according to any one of “1” to “3” above may include the following configuration, for example. At least one of a liquid inlet hole and a gas-discharge valve is provided to at least one of the four connection surfaces.

8. The power storage module according to “3” above may include the following configuration, for example. In a plane viewed in a direction of a normal to the opposite surface, the bus bar extends parallel to the stacking direction to connect two of the single cells together.

9. The power storage module according to “3” above may include the following configuration, for example. In a plane viewed in a direction of a normal to the opposite surface, the bus bar extends in a direction crossing the stacking direction to connect two of the single cells together.

10. The power storage module according to “3” above may include the following configuration, for example. At least part of the bus bar is fixed to the opposite surface.

In an alternate arrangement, misalignment of single cells may occur. With the bus bar being fixed to the opposite surface, misalignment is expected to be reduced. For example, an adhesive agent and/or the like may be used to fix the bus bar to the opposite surface.

11. The power storage module according to “3” above may include the following configuration, for example. In a projected view where the positive electrode terminal, the negative electrode terminal, and the opposite surface are projected in the stacking direction to a hypothetical plane orthogonal to the opposite surface, edges of the positive electrode terminal and the negative electrode terminal lie on an inner side of the opposite surface.

In the projected view according to “11” above, with the edges of the terminals not extending off the opposite surface, space efficiency is expected to be enhanced.

12. The power storage module according to “11” above may include the following configuration, for example. In the projected view, the edges of the positive electrode terminal and the negative electrode terminal are in contact with the opposite surface.

In the projected view according to “11” above, with the edges of the terminals being in contact with the opposite surface, space efficiency is expected to be enhanced.

13. The power storage module according to “11” above may include the following configuration, for example. The bus bar has a first main face and a second main face. The first main face faces the single cell. The second main face is located opposite to the first main face. In the projected view where the second main face present on an axis of the positive electrode terminal or the negative electrode terminal is also projected, the second main face lies on the inner side of the opposite surface.

In the projected view according to “13” above, with the bus bar not extending off the opposite surface, space efficiency is expected to be enhanced.

14. The power storage module according to above “13” may include the following configuration, for example. In the projected view, the second main face is in contact with the opposite surface.

In the projected view according to “13” above, with the bus bar being in contact with the opposite surface, space efficiency is expected to be enhanced.

15. A power storage device comprises the power storage module according to any one of “1” to “14” above.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating an example of a vehicle according to the present embodiment.

FIG. 2 is a schematic perspective view illustrating an example of a power storage device according to the present embodiment.

FIG. 3 is a first schematic perspective view illustrating an example of a power storage module according to the present embodiment.

FIG. 4 is a schematic perspective view illustrating an example of a single cell according to the present embodiment.

FIG. 5 is a schematic plan view illustrating an example of a bus bar according to the present embodiment.

FIG. 6 is a second schematic perspective view illustrating an example of a power storage module according to the present embodiment.

FIG. 7 is a first schematic cross-sectional view illustrating an example of a bus bar according to the present embodiment.

FIG. 8 is a second schematic cross-sectional view illustrating an example of a bus bar according to the present embodiment.

FIG. 9 is a first projected view according to the present embodiment.

FIG. 10 is a second projected view according to the present embodiment.

FIG. 11 is a conceptual view illustrating an example of an end-part structure according to the present embodiment.

### DESCRIPTION OF THE EMBODIMENTS

### Terms and Phrases

Terms such as “comprise”, “include”, and “have”, and other similar terms are open-ended terms. In an open-ended term, in addition to a stated component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

“Rectangular-parallelepiped-like shape” has six outer surfaces. The planar shape of each outer surface may be a rectangle-like shape or a square-like shape, for example. Expressions such as “rectangular-parallelepiped-like shape”, “rectangle-like shape”, and “square-like shape” mean that the shape does not need to be the exact rectangular parallelepiped, rectangle, square, or the like in the geometrically strictest sense. For example, each of the outer surfaces may not be a flat plane. For example, each outer surface may be curved inwardly or outwardly. For example, each angle may be roundish. For example, each line may not be straight. For example, one outer surface and another outer surface may not be orthogonal to each other at where these outer surfaces are connected to each other. For example, the part at which one outer surface and another outer surface are connected to each other (ridge, edge) may be roundish. For example, due to the roundish connection part at which one outer surface and another outer surface are connected, the boundary between these two outer surfaces may be not clear. For example, a welding bead and/or the like may be formed at where one outer surface and another outer surface are connected to each other. For example, the areas of two facing outer surfaces may be different from each other. The rectangular-parallelepiped-like shape includes “a cube-like shape”, “a quadrangular-prism-like shape”, and the like. A cube-like shape and a quadrangular-prism-like shape do not need to be the exact cube and the exact quadrangular prism, respectively.

Expressions that describe relative or absolute positional relationships, such as “contact with”, “flush with”, and “the same”, do not only mean the exact positional relationships. These expressions also mean those positional relationships including tolerances and/or errors. For example, as long as substantially the same or similar functions are obtained, the relative positional relationship between the target objects may vary. It should be noted that in a projected view, “an aspect in which a target object lies on the inner side of a surface” includes “an aspect in which a target object is in contact with a surface”.

A singular form may also include its plural meaning, unless otherwise specified. For example, “a single cell” may mean a plurality of single cells (a group of single cells).

“At least one of A and B” includes “A” only, “B” only, and “both A and B”. “At least one of A and B” may also be expressed as “A and/or B”.

“Width of a case” means the outer dimension in the W direction. “Height of a case” means the outer dimension in the H direction. “Thickness of a case” means the outer dimension in the T direction. The W direction, the H direction, and the T direction may be orthogonal to each other. The H direction may or may not be parallel to the vertical direction, for example. The H direction may or may not be parallel to the direction of travel of the vehicle, for example. The T direction may or may not be parallel to the direction of travel of the vehicle, for example.

In the present embodiment, a power storage device and a power storage module “for vehicle applications” will be described. However, vehicle applications are merely an example of the purpose of use. The purpose of use is not particularly limited.

“Terminal” collectively refers to “positive electrode terminal” and “negative electrode terminal”. The term “terminal” refers to at least one of a positive electrode terminal and a negative electrode terminal.

### Vehicle

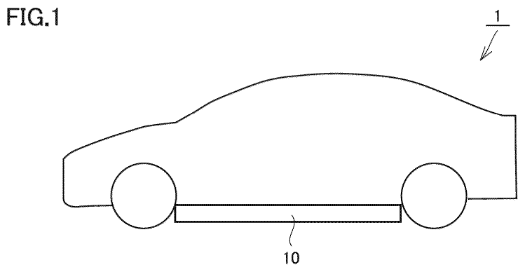

FIG. 1 is a conceptual view illustrating an example of a vehicle according to the present embodiment. A vehicle 1 may be a BEV (Battery Electric Vehicle), an HEV (Hybrid Electric Vehicle), a PHEV (Plug-in Hybrid Electric Vehicle), or the like, for example. Vehicle 1 includes a power storage device 10. The position to mount the power storage device 10 is not particularly limited. For example, power storage device 10 may be placed under the floor of vehicle 1.

### Power Storage Device

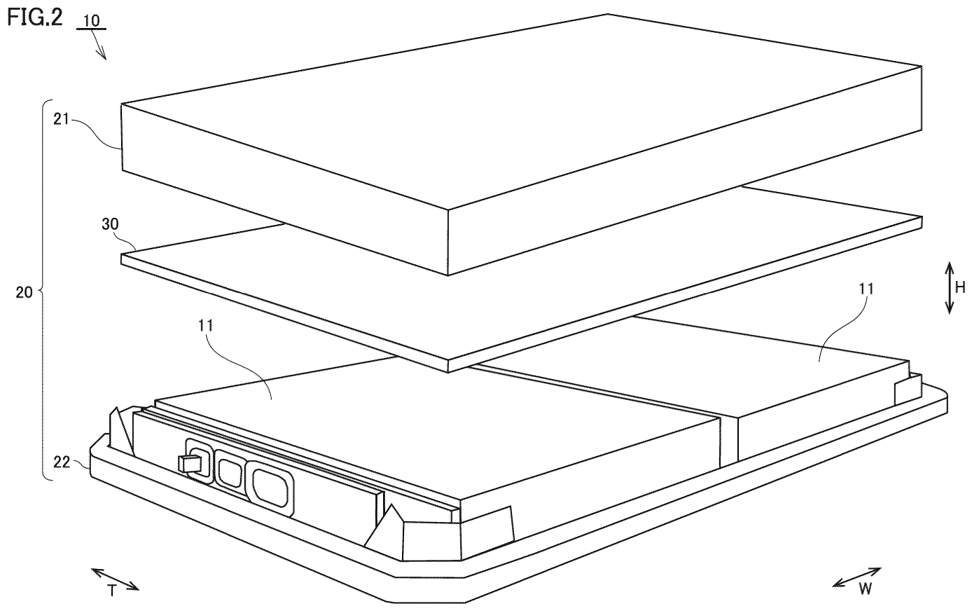

FIG. 2 is a schematic perspective view illustrating an example of a power storage device according to the present embodiment. Power storage device 10 includes a power storage module 11. Power storage device 10 may include a plurality of power storage modules 11. Power storage device 10 may include one to four power storage modules 11, for example. Power storage device 10 may further include a housing case 20, a cooler 30, and the like, for example. Housing case 20 accommodates power storage module 11. Housing case 20 may include an upper case 21 and a lower case 22. There may be a gap between power storage modules 11. For example, a divider (not illustrated) may be provided between power storage modules 11. For example, cooler 30 may be provided on the upper case 21 side, or may be provided on the lower case 22 side. Cooler 30 is capable of cooling power storage module 11. Cooler 30 may include a coolant flow path and/or the like, for example.

### Power Storage Module

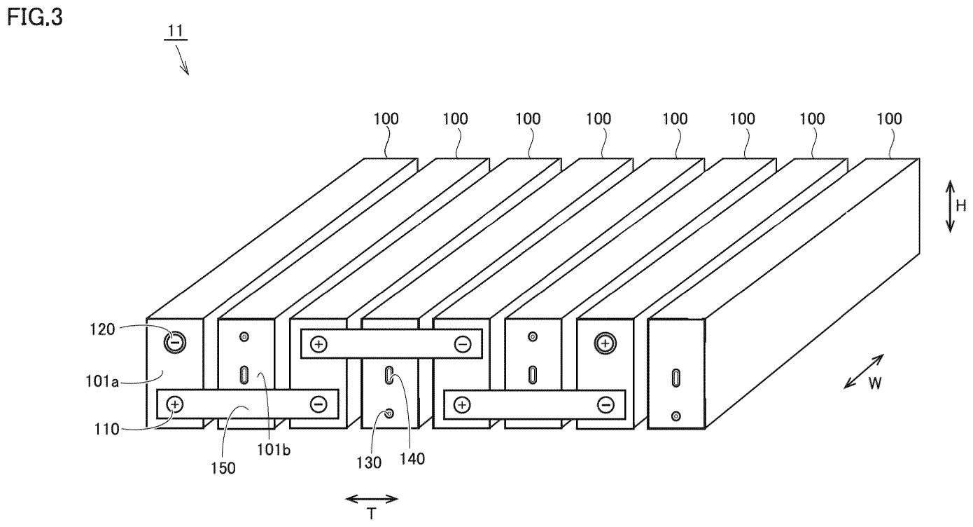

FIG. 3 is a first schematic perspective view illustrating an example of a power storage module according to the present embodiment. Power storage module 11 includes a plurality of single cells 100. The plurality of single cells 100 may be electrically connected either in series or in parallel. As an example, a series connection is illustrated. The number of single cells 100 is not particularly limited as long as it is two or more. For example, the number of single cells 100 may be from 2 to 200, or from 10 to 150, or from 50 to 100.

### Single Cell

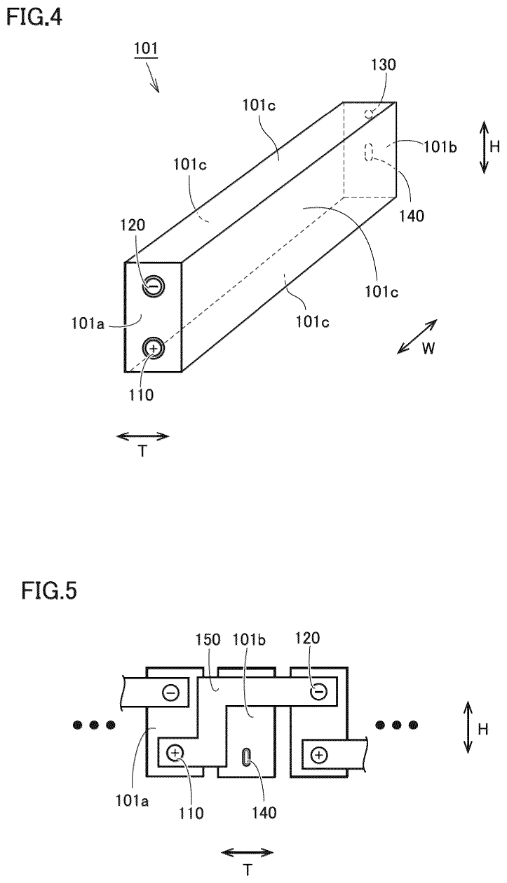

FIG. 4 is a schematic perspective view illustrating an example of a single cell according to the present embodiment. Single cell 100 is the smallest constituent unit of power storage device 10. Single cell 100 may be a lithium-ion battery, for example. Each single cell 100 includes a case 101. Case 101 accommodates a power generation element (not illustrated). The power generation element may be a stack-type one, or may be a wound-type one. The power generation element includes a positive electrode active material, a negative electrode active material, and an electrolyte, for example. The positive electrode active material may include lithium iron phosphate, lithium-nickel composite oxide, and/or the like, for example. The negative electrode active material may include graphite, silicon oxide, silicon, and/or the like, for example. The electrolyte may be liquid, gel, or solid.

### Case

Case 101 may be made of metal, for example. Case 101 may be made of aluminum alloy, for example. Case 101 has a rectangular-parallelepiped-like shape. Case 101 may be a long plate, for example. The width of case 101 may be 500 mm or more, or 750 mm or more, or 1000 mm or more, for example. The width of case 101 may be 2000 mm or less, or 1500 mm or less, or 1250 mm or less, for example. The height of case 101 may be 50 mm or more, or 75 mm or more, or 100 mm or more, for example. The height of case 101 may be 200 mm or less, or 150 mm or less, or 125 mm or less, or 100 mm or less, for example. The thickness of case 101 may be 5 mm or more, or 10 mm or more, or 15 mm or more, or 20 mm or more, for example. The thickness of case 101 may be 30 mm or less, or 25 mm or less, or 20 mm or less, or 15 mm or less, or 10 mm or less, for example.

The ratio of width to height may be from 5 to 20, for example. The ratio of width to thickness may be from 50 to 200, for example.

### Terminal Surface, Opposite Surface, Connection Surface

Case 101 has six outer surfaces. The six outer surfaces are a terminal surface 101a, an opposite surface 101b, and four connection surfaces 101c. That is, single cell 100 has a single terminal surface 101a. To terminal surface 101a, both a positive electrode terminal 110 and a negative electrode terminal 120 are provided. Each of positive electrode terminal 110 and negative electrode terminal 120 is electrically connected to the power generation element (not illustrated) inside the case 101. Opposite surface 101b is located opposite to terminal surface 101a. Each of the four connection surfaces 101c connects terminal surface 101a and opposite surface 101b to each other.

For example, the four connection surfaces 101c may constitute a tubular case body. For example, the four connection surfaces 101c may constitute a single-piece component, or may be four plates assembled together. For example, the case body may have the shape of a cylindrical prism. For example, each of terminal surface 101a and opposite surface 101b may constitute a cap. The cap may close an opening of the case body. For example, the cap and the case body may be bonded together by laser beam welding.

For example, the four connection surfaces 101c and opposite surface 101b may constitute the case body. For example, the case body may be a vessel that has a bottom face. For example, the case body may be a vessel having the shape of a cylindrical prism with a bottom. Opposite to the bottom face, the case body may have an opening. Terminal surface 101a may constitute a cap. The cap may close the opening of the case body.

At least one of the four connection surfaces 101c may have the largest area among the six outer surfaces. For example, one connection surface 101c may have the largest area. For example, two connection surfaces 101c facing each other may have the largest area. For example, all the four connection surfaces 101c may equally have the largest area. Alternatively, at least one of the four connection surfaces 101c may have the smallest area among the six outer surfaces. Alternatively, the area of at least one of the four connection surfaces 101c may be between the largest area and the smallest area.

For example, terminal surface 101a may have the smallest area among the six outer surfaces. For example, terminal surface 101a may have the largest area among the six outer surfaces. For example, the area of terminal surface 101a may be between the largest area and the smallest area. For example, the area of opposite surface 101b may be the same as, or different from, that of terminal surface 101a.

For example, among all the facing pairs out of the six outer surfaces, terminal surface 101a and opposite surface 101b may have the longest distance between them. For example, the distance between terminal surface 101a and opposite surface 101b may be the shortest. For example, the distance between terminal surface 101a and opposite surface 101b may be between the longest distance and the shortest distance. For example, the distance between connection surfaces 101c may be the longest. For example, the distance between connection surfaces 101c may be the shortest. For example, the distance between connection surfaces 101c may be between the longest distance and the shortest distance. For example, as illustrated in FIG. 4, the distance between terminal surface 101a and opposite surface 101b may be the outer dimension in the W direction (the width). For example, the distance between connection surfaces 101c may be the outer dimension in the T direction (the thickness). For example, the distance between connection surfaces 101c may be the outer dimension in the H direction (the height). When the distance between two outer surfaces is not uniform, the distance between the two outer surfaces refers to the shortest distance between the two.

### Liquid Inlet Hole, Gas-Discharge Valve

For example, at least one of a liquid inlet hole 130 and a gas-discharge valve 140 may be provided to opposite surface 101b. For example, at the time of assembly of single cell 100, an electrolyte solution (a liquid electrolyte) may be injected through liquid inlet hole 130 into case 101. For example, liquid inlet hole 130 may be closed with a plug (not illustrated). For example, when the internal pressure of case 101 has risen, gas may be discharged through gas-discharge valve 140. Alternatively, at least one of liquid inlet hole 130 and gas-discharge valve 140 may be provided to at least one of the four connection surfaces 101c. Alternatively, at least one of liquid inlet hole 130 and gas-discharge valve 140 may be provided to terminal surface 101a. In terminal surface 101a, liquid inlet hole 130 and gas-discharge valve 140 may be interposed between positive electrode terminal 110 and negative electrode terminal 120, for example.

### Alternate Arrangement

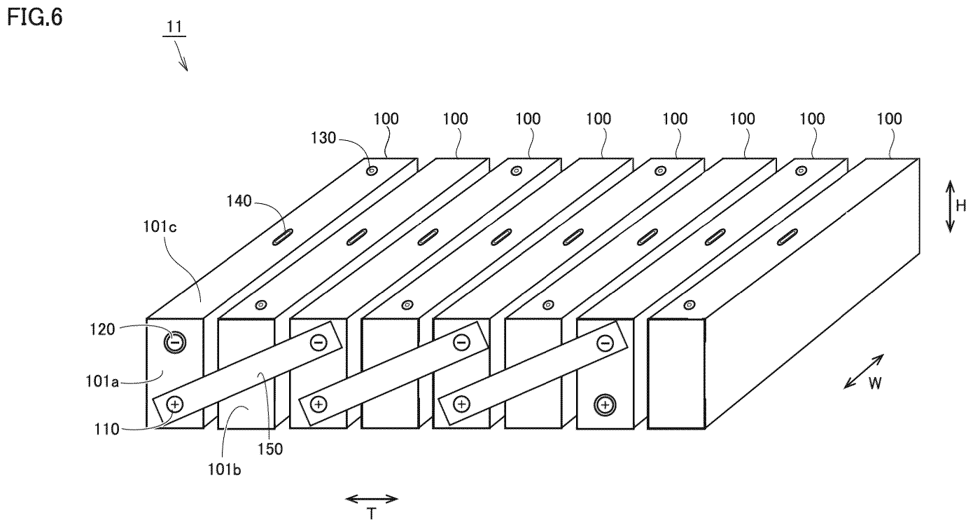

The plurality of single cells 100 are stacked in the stacking direction (the T direction). Each of terminal surface 101a and opposite surface 101b is parallel to the stacking direction. In the stacking direction, single cells 100 may be adhered to one another. In the stacking direction, there may be gaps between single cells 100. In the stacking direction, the plurality of single cells 100 form an alternate arrangement. More specifically, as illustrated in FIG. 3, the plurality of single cells 100 are aligned in the stacking direction in such a manner that terminal surface 101a alternates with opposite surface 101b. In the alternate arrangement, unevenness in temperature is expected to be reduced. The orientation of single cells 100 in the H direction may be alternate as in FIG. 3, or may be uniform as in FIG. 6.

Power storage module 11 may have a single arrangement pattern, for example. More specifically, in power storage module 11, all the single cells 100 may constitute an alternate arrangement. As long as an alternate arrangement is included, power storage module 11 may include a plurality of arrangement patterns. For example, at an end in the stacking direction, the arrangement pattern may change. Among all the single cells 100 in power storage module 11, at least 50%, or at least 80%, or at least 90% of single cells 100 may constitute an alternate arrangement, for example.

### Bus Bar

As illustrated in FIG. 3, power storage module 11 may further include a bus bar 150. Bus bar 150 may extend in the stacking direction (the T direction), for example. In the stacking direction, bus bar 150 may connect two single cells 100 together, leaving one single cell sandwiched therebetween. Bus bar 150 may be made of metal, for example. Bus bar 150 may be a plate, for example. Bus bar 150 may have a hole in it. A terminal may be inserted through the hole and, thereby, the terminal may be connected to bus bar 150. For example, bus bar 150 may be welded to an end face of a terminal.

For example, in FIG. 3, the W direction is the direction of a normal to opposite surface 101b. For example, as illustrated in FIG. 3, in a plane viewed in the direction of a normal to opposite surface 101b, bus bar 150 may extend parallel to the stacking direction (the T direction) to connect two single cells 100 together, for example. Bus bar 150 may extend straight, for example. Bus bar 150 may extend in a curved manner, for example. Bus bar 150 may be bent, for example.

For example, as illustrated in FIG. 3, in a plane viewed in the direction of a normal to opposite surface 101b, bus bar 150 may have a shape that does not overlap gas-discharge valve 140. When bus bar 150 does not overlap gas-discharge valve 140, gas-discharge valve 140 is capable of functioning smoothly without being interfered by bus bar 150.

Bus bar 150 may have a shape that overlaps liquid inlet hole 130. More specifically, liquid inlet hole 130 may be positioned directly below the bus bar 150.

FIG. 5 is a schematic plan view illustrating an example of a bus bar according to the present embodiment. In FIG. 5, a plane viewed in the direction of a normal to opposite surface 101b is illustrated. For example, bus bar 150 may be curved or bent in an in-plane direction so that it does not overlap gas-discharge valve 140. The in-plane direction in FIG. 5 is a direction that does not stick out of the paper surface of FIG. 5. The in-plane direction in FIG. 5 includes the T direction and the H direction.

FIG. 6 is a second schematic perspective view illustrating an example of a power storage module according to the present embodiment. In FIG. 6, the W direction is the direction of a normal to opposite surface 101b. For example, as illustrated in FIG. 6, in a plane viewed in the direction of a normal to opposite surface 101b, bus bar 150 may extend in a direction crossing the stacking direction (the T direction) to connect two single cells 100 together.

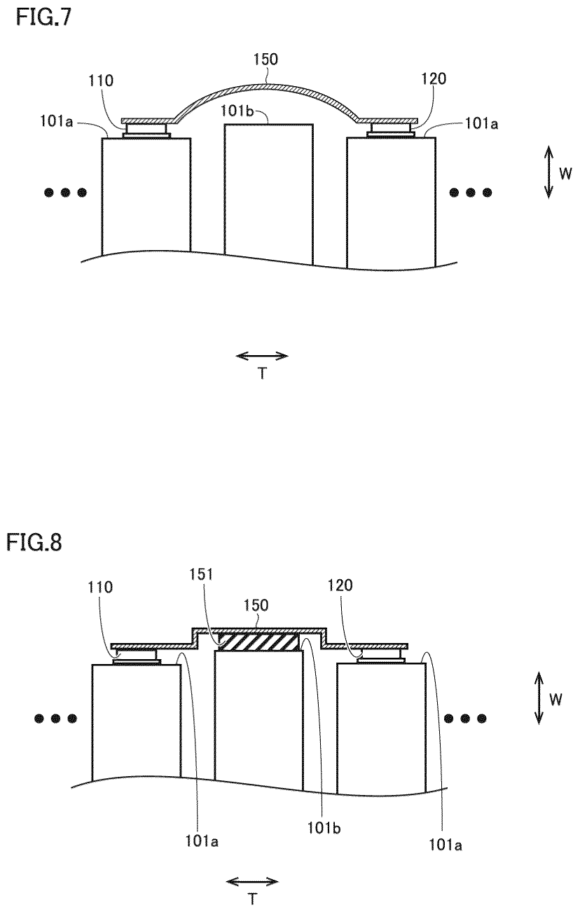

FIG. 7 is a first schematic cross-sectional view illustrating an example of a bus bar according to the present embodiment. As illustrated in FIG. 7, bus bar 150 may extend in such a manner that it straddles opposite surface 101b present between terminal surfaces 101a. For example, bus bar 150 may be curved in an out-of-plane direction. The out-of-plane direction in FIG. 7 is a direction within the paper surface of FIG. 7 that crosses the T direction. The out-of-plane direction in FIG. 7 includes the W direction. That is, bus bar 150 may have a portion that extends in a direction away from opposite surface 101b. When there is a gap between bus bar 150 and opposite surface 101b, gas-discharge valve 140 is capable of functioning smoothly without being interfered by bus bar 150, for example. Bus bar 150 may have a bridge-like shape, for example. Bus bar 150 may have an arc-like shape, for example. Bus bar 150 may be curved, describing a parabola, for example. Bus bar 150 may be curved in the U shape, for example. Bus bar 150 may be bent in the V shape, for example.

FIG. 8 is a second schematic cross-sectional view illustrating an example of a bus bar according to the present embodiment. As illustrated in FIG. 8, bus bar 150 may be bent in an out-of-plane direction to form a sharp-cornered convex shape. As described above, to opposite surface 101b present between terminal surfaces 101a, liquid inlet hole 130, gas-discharge valve 140, and the like may be provided.

At least part of bus bar 150 may be fixed to opposite surface 101b. For example, bus bar 150 may be fixed to opposite surface 101b by way of a fixing member 151. Fixing member 151 may be electrically insulating. Fixing member 151 may include an adhesive agent and/or the like, for example. The adhesive agent may include epoxy resin, acrylic resin, and/or the like, for example. For example, when bus bar 150 connects two single cells 100 leaving one single cell sandwiched therebetween, misalignment of single cells 100 may occur. With bus bar 150 being fixed to opposite surface 101b, misalignment is expected to be reduced.

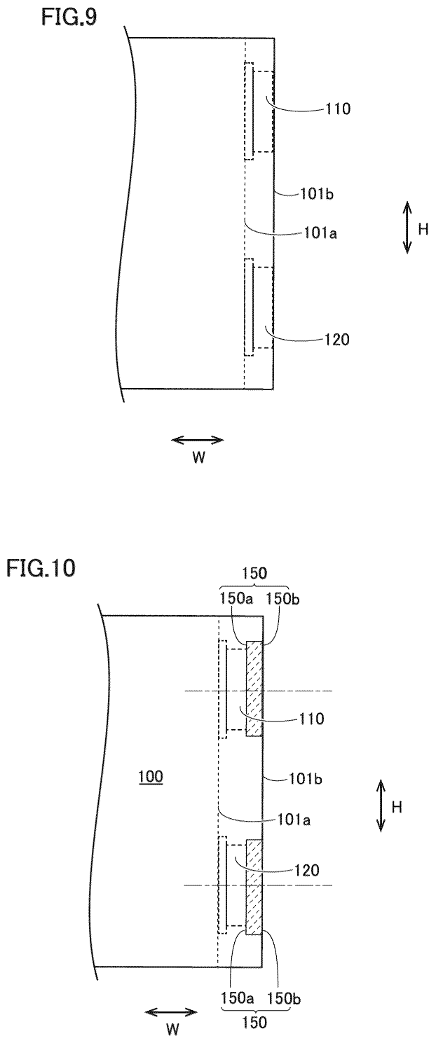

FIG. 9 is a first projected view according to the present embodiment. The first projected view is a view where positive electrode terminal 110, negative electrode terminal 120, and opposite surface 101b are projected in the stacking direction (the T direction) to a hypothetical plane orthogonal to opposite surface 101b. For example, in the first projected view, the edges of positive electrode terminal 110 and negative electrode terminal 120 may lie on the inner side of opposite surface 101b. In the first projected view, with the edges of the terminals not extending off the opposite surface 101b, space efficiency is expected to be enhanced. For example, in the first projected view, the edges of the terminals may be in contact with opposite surface 101b. In the first projected view, with the edges of the terminals being in contact with opposite surface 101b, space efficiency is expected to be enhanced.

FIG. 10 is a second projected view according to the present embodiment. The second projected view is a view where bus bar 150 is projected in the stacking direction to the hypothetical plane in the first projected view. Each of the dash-dot lines in the second projected view represents the axis of a terminal. Bus bar 150 may have a first main face 150a and a second main face 150b. First main face 150a faces single cell 100. Second main face 150b is located opposite to first main face 150a. For example, in the second projected view, second main face 150b on the axis of a terminal may lie on the inner side of opposite surface 101b. In the second projected view, with second main face 150b not extending off the opposite surface 101b, space efficiency is expected to be enhanced. For example, bus bar 150 connected to positive electrode terminal 110 may lie on the inner side of opposite surface 101b. For example, bus bar 150 connected to negative electrode terminal 120 may lie on the inner side of opposite surface 101b. For example, both the bus bar 150 connected to positive electrode terminal 110 and the bus bar 150 connected to negative electrode terminal 120 may lie on the inner side of opposite surface 101b.

For example, in the second projected view, second main face 150b may be in contact with opposite surface 101b. In the second projected view, with second main face 150b being in contact with opposite surface 101b, space efficiency is expected to be enhanced. In the second projected view, with second main face 150b being in contact with opposite surface 101b, second main face 150b may be flush with opposite surface 101b. “Being flush with” means that two surfaces are substantially on the same plane. As a result, the outer frame of power storage module 11 may be smooth, for example.

### End-Part Structure

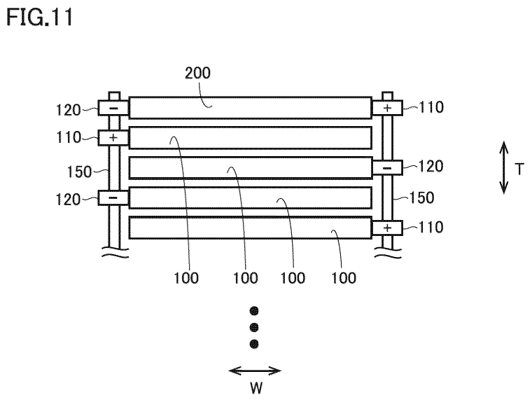

FIG. 11 is a conceptual view illustrating an example of an end-part structure according to the present embodiment. For example, at an end in the stacking direction (the T direction), the terminal of single cell 100 may be electrically connected to housing case 20. For example, at an end of power storage module 11, a both-side type single cell 200 may be placed. Both-side type single cell 200 has two terminal surfaces. These two terminal surfaces face each other. To one of the terminal surfaces, positive electrode terminal 110 is provided. To the other terminal surface, negative electrode terminal 120 is provided. With both-side type single cell 200 placed at an end of the stacking direction, all the plurality of single cells 100 may be connected in series. Alternatively, single cells 100 at both ends may be connected to each other with a long bus bar (not illustrated).

The plurality of single cells 100 may form a single row. The plurality of single cells 100 may form two or more rows, for example. When the plurality of single cells 100 form a plurality of rows, these rows may be electrically in parallel or in series. The rows may be aligned in parallel, for example. The number of single cells 100 forming a single row may be from 2 to 50, for example.

What is claimed is:

1. A power storage module comprising a plurality of single cells, wherein
the plurality of the single cells are stacked in a stacking direction,
each of the plurality of the single cells includes a case,
the case has a rectangular-parallelepiped-like shape with six outer surfaces,
the six outer surfaces include a terminal surface and an opposite surface,
the terminal surface is an outer surface, among the six outer surfaces, to which a positive electrode terminal and a negative electrode terminal are provided,
the opposite surface is an outer surface, among the six outer surfaces, that is located opposite to the terminal surface,
each of the terminal surface and the opposite surface is parallel to the stacking direction, and
the plurality of the single cells are aligned in the stacking direction in such a manner that the terminal surface alternates with the opposite surface.

2. The power storage module according to claim 1, wherein
the six outer surfaces further include four connection surfaces,
each of the four connection surfaces connects the terminal surface and the opposite surface to each other, and
among all facing pairs out of the six outer surfaces, the terminal surface and the opposite surface have the longest distance between them.

3. The power storage module according to claim 1, further comprising a bus bar, wherein
the bus bar extends in the stacking direction, and
the bus bar connects two of the single cells together, leaving one single cell sandwiched therebetween.

4. The power storage module according to claim 3, wherein at least one of a liquid inlet hole and a gas-discharge valve is provided to the opposite surface.

5. The power storage module according to claim 4, wherein
the gas-discharge valve is provided to the opposite surface, and
in a plane viewed in a direction of a normal to the opposite surface, the bus bar has a shape that does not overlap the gas-discharge valve.

6. The power storage module according to claim 3, wherein
the bus bar extends in such a manner that it straddles the opposite surface present between the terminal surfaces, and
the bus bar includes a portion that extends in a direction away from the opposite surface.

7. The power storage module according to claim 2, wherein at least one of a liquid inlet hole and a gas-discharge valve is provided to at least one of the four connection surfaces.

8. The power storage module according to claim 3, wherein
in a plane viewed in a direction of a normal to the opposite surface, the bus bar extends parallel to the stacking direction to connect two of the single cells together.

9. The power storage module according to claim 3, wherein
in a plane viewed in a direction of a normal to the opposite surface, the bus bar extends in a direction crossing the stacking direction to connect two of the single cells together.

10. The power storage module according to claim 3, wherein at least part of the bus bar is fixed to the opposite surface.

11. The power storage module according to claim 3, wherein in a projected view where the positive electrode terminal, the negative electrode terminal, and the opposite surface are projected in the stacking direction to a hypothetical plane orthogonal to the opposite surface, edges of the positive electrode terminal and the negative electrode terminal lie on an inner side of the opposite surface.

12. The power storage module according to claim 11, wherein in the projected view, the edges of the positive electrode terminal and the negative electrode terminal are in contact with the opposite surface.

13. The power storage module according to claim 11, wherein
the bus bar has a first main face and a second main face,
the first main face faces the single cell,
the second main face is located opposite to the first main face, and
in the projected view where the second main face present on an axis of the positive electrode terminal or the negative electrode terminal is also projected, the second main face lies on the inner side of the opposite surface.

14. The power storage module according to claim 13, wherein in the projected view, the second main face is in contact with the opposite surface.

15. A power storage device comprising the power storage module according to claim 1.
